(19) United States
(12) Patent Application Publication
(10) Pub. No.: US 2013/0205948 A1
(43) Pub. Date: Aug. 15, 2013

(54) DRIVE TRAIN FOR A MOTOR VEHICLE

(71) Applicants: Gerhard Meier-Burkamp, Heidenheim (DE); Helmut Krieger, Langenau (DE)

(72) Inventors: Gerhard Meier-Burkamp, Heidenheim (DE); Helmut Krieger, Langenau (DE)

(21) Appl. No.: 13/587,589

(22) Filed: Aug. 16, 2012

Related U.S. Application Data
(63) Continuation of application No. PCT/EP2011/000938, filed on Feb. 25, 2011.

(30) Foreign Application Priority Data
Mar. 25, 2010 (DE) 10 2010 012 965.8

(51) Int. Cl. F02N 7/00

(52) U.S. Cl. CPC F02N 7/00
USPC 74/7 C

(57) ABSTRACT

A drive train for a motor vehicle includes: a primary drive unit; a powershift transmission which is arranged behind the primary drive unit in the direction of the power flow; a starting element which is arranged in the power flow between the primary drive unit and the powershift transmission and which includes at least one coupling; an electrical machine which is arranged in the power flow between the starting element and the powershift transmission; and at least one retarder which is arranged in the power flow before and/or after the powershift transmission.

### CROSS REFERENCE TO RELATED APPLICATIONS

This is a continuation of PCT application No. PCT/EP2011/000938, entitled “DRIVETRAIN FOR A MOTOR VEHICHLE”, filed Feb. 25, 2011, which is incorporated herein by reference.

### BACKGROUND OF THE INVENTION

1. Field of the Invention

The invention relates to a drive train for a motor vehicle, including: a primary drive unit; a powershift transmission which is arranged behind the primary drive unit in the direction of the power flow; a starting element which is arranged in the power flow between the primary drive unit and the powershift transmission and which comprises at least one coupling; an electrical machine which is arranged in the power flow between the starting element and the powershift transmission. In particular, the invention further relates to the use of such a drive train for a utility vehicle, preferably for a city bus, as can be used in urban transport for example.

2. Description of the Related Art

Hybridized drive systems which comprise a primary drive unit on the one hand and an electrical machine on the other hand are generally known from the general state of the art. The primary drive unit frequently concerns an internal combustion engine such as a diesel engine for example. The electrical machine is used in the drive train for recuperating brake energy on the one hand and for driving the motor vehicle with the stored energy on the other hand, either alone or in addition to the drive power from the primary drive unit. Typically, the electrical machine is installed for this purpose parallel to the power path of the power applied via the primary drive unit.

One of the possibilities is the arrangement of the electrical machine at the output of the transmission. This leads to the disadvantage that the electrical machine needs to cover a very large torque range, especially when using utility vehicles such as city buses or intercity coaches. An electrical machine of a comparatively large overall volume is required which needs to apply drive torques up to 7,000 Nm. Alternatively or in addition, a gear step can be used for gear reduction between the electrical machine and a drive train. This shifts the requirement merely from a large torque range to a large useful speed range of the electrical machine, so that the problems remain the same.

An alternative configuration provides that the electrical machine is arranged at the transmission input. Since a hydrodynamic component is frequently provided in utility vehicle transmissions either as a starting element or as a transmission-internal converter, this leads to the disadvantage that the electrical machine will co-drive the hydrodynamic component. This then leads to problems in the configuration of the hydrodynamic component. The characteristic curves of internal combustion engines and electrical machines differ considerably from one another. When the hydrodynamic component is to operate with both machines however it also needs to be configured for both machines. This is very complex in respect of conventional sizes and types.

A further possibility would be to use the electrical machine instead of the converter. Although this would have no effect on the overall space in contrast to the cases as described above in which additional overall space will be required, the functionality of the transmission will be clearly reduced, especially when the energy storage unit has been discharged. Since certain requirements such as starting on an incline or creeping travel uphill can be realized by the converter for example, the same is simultaneously required by the electrical machine. Depending on the configuration of the electrical machine, this is difficult or even impossible. If in addition there is insufficient stored electrical power, the desired functionality cannot be provided at all.

A further problem of such add-on accessories will arise when the fulfillment of a demand for a retarder, especially a wear-free retarder, is involved. In order to enable fulfilling this demand via the electrical machine in operation as a generator, it is necessary to take up a very high electric power in braking operation especially in a utility vehicle of a comparatively high overall weight. This generally leads to a considerably overdimensioned storage unit or the energy needs to be converted into heat at braking resistors. A starting element for a motor vehicle is known in the further general state of the art from EP 2 025 550 A2, which shows a starting clutch which is arranged hydrodynamically. The secondary side is connected with the rotor in a torque-proof manner, which is connected with a stator via electromagnetic interaction. A braking device for the secondary side of the hydrodynamic coupling can thereby be created by the electrical machine arranged in this manner. However, there is a distinct limitation provided by the torque-proof connection between the electrical machine and the secondary side of the hydrodynamic starting element because the static internal combustion machine would need to be driven via the hydrodynamic cycle in such cases via the electrical machine. This would lead to drag losses especially at high rotational speeds.

Reference is hereby made to the German published patent application DE 10 2008 015 226 A1 concerning the closest state of the art.

Reference is further made to DE 10 2007 004 462 A1, U.S. Pat. No. 3,625,323 A, DE 102 19 080 A, JP 2003 220 842 A and US 2009/283 344 A1 concerning the further state of the art.

It is the object of the present invention, and what is needed in the art is, to provide a drive train for a motor vehicle which avoids the aforementioned problems and still enables effective hybridization with a primary drive unit and an electrical machine.

### SUMMARY OF THE INVENTION

In accordance with the invention, this object is achieved by, and the present invention provides, at least one retarder which is arranged in the power flow before and/or after the powershift transmission. A preferred use for the drive train in accordance with the invention is for the drive of a utility vehicle, especially a city bus or a bus for urban transport, the drive train being for the motor vehicle and including: a primary drive unit; a powershift transmission which is arranged behind the primary drive unit in the direction of the power flow; a starting element which is arranged in the power flow between the primary drive unit and the powershift transmission and which comprises at least one coupling; an electrical machine which is arranged in the power flow between the starting element and the powershift transmission; characterized in that at least one retarder is arranged in the power flow before and/or after the powershift transmission.

The configuration in accordance with the invention provides that a starting element is provided which comprises at least one coupling. Said starting element is arranged in the power flow (the direction of which represents the drive case here) between the primary drive unit and the powershift transmission. So far, this corresponds to the configuration according to the state of the art. The electrical machine is now arranged in accordance with the invention in the power flow between the starting element and the powershift transmission. The electrical machine is connected with the input shaft or shafts of the powershift transmission. As a result, the vehicle can be driven via the electrical machine and the powershift transmission without having to co-move the primary drive unit which is static in this case and which can especially be arranged as an internal combustion engine. This is decisively advantageous for the efficiency during purely electrical driving. As a result of the arrangement of the electrical machine before the powershift transmission, it can be designed with a respectively narrowed speed and/or torque range, so that a highly compact and highly efficient electrical machine can be used with small overall space and a comparatively low required spread of the load.

In special types of operation such as start/stop operation, i.e. the deactivation of the primary drive unit during temporary standstill of the vehicle at a red traffic light for example, the primary drive unit can thereby easily be deactivated. The renewed commencement of forward motion can then exclusively occur via the electrical machine (at least in the initial phase) without having to drag the primary drive unit. Even slow travel such as through low-traffic locations or slow travel downhill can be realized by the electrical machine alone, so that the primary drive unit such as an internal combustion engine can remain in the stop mode and therefore does not require any energy and does not cause any emissions. Renewed starting will only be necessary when the energy storage units for the electrical machine will become discharged or if power or torque is required which cannot be provided by the electrical machine (alone). In this case, the primary drive unit can be reactivated. This configuration offers the decisive advantage that exhaust gas emissions and noise emissions are avoided or considerably reduced by the operation of the primary drive unit in the low-load range.

The drive train with the hybridization by the inclusion of the electrical machine in accordance with the invention allows a very free adjustment of the size of the electrical machine. This allows arranging the drive train as a micro-hybrid, mild hybrid or full hybrid.

The storage capacity will be insufficient in certain states, so that insufficient braking torque will be provided by the electrical machine. In this case, a braking torque can be applied in addition to the electrical machine by a retarder in the power flow before and/or after the powershift transmission. Potential retarders are a primary retarder, a secondary retarder and/or the use of a hydrodynamic coupling as a retarder.

In an advantageous embodiment of the drive train in accordance with the invention it is provided that the starting element is arranged as a hydrodynamic element. Such a hydrodynamic element, for which there are a large number of different configurations such as converters, couplings with controlled or constant filling, permanently filled hydrodynamic coupling with throttle element or the like, allows starting in a wear-free manner with a transmission behavior that can be influenced, despite the frequently high torques which are required for starting a utility vehicle.

In accordance with an especially favorable and advantageous further development of the drive train in accordance with the invention it is further provided that the hydrodynamic element is connected behind the secondary wheel via a freewheel with the input shaft of the powershift transmission in the direction of the power flow, the direction of which shall further be defined for the present text by the drive case. As a result of this configuration with the freewheel, a reversal of the primary and the secondary side of the hydrodynamic element in the starting element is no longer possible.

In accordance with a highly advantageous further development thereof, the secondary wheel of the hydrodynamic element, when arranged as a coupling, can be stalled by a braking device. An introduction of power by the powershift transmission in a “rearward” fashion can be realized in this manner with the stalled secondary side of the hydrodynamic coupling as a result of the provided freewheel, so that the power will reach the primary side of the hydrodynamic coupling. A wear-free retarder is realized in this manner in that when the hydrodynamic coupling is filled it is used as a hydrodynamic retarder with rotating primary wheel and stalled secondary wheel. Since such a retarder will then be arranged on the side of the powershift transmission facing the primary drive unit, it is also known as a primary retarder. In addition to braking via the electrical machine in operation as a generator, it is possible to brake in a wear-free fashion via the hydrodynamic coupling when used as a hydrodynamic retarder. This leads to the decisive advantage that when the electrical storage unit is full or in the case of insufficient power take-off for applying the required braking torque in the electrical machine it is possible to brake additionally with the retarder. Introduced braking power will be converted therein into heat in the working medium in the known manner and discharged via a cooling cycle or the like. This is possible in a very simple, efficient and reliable manner.

In a further highly advantageous embodiment of the invention, the starting element can also be arranged as a friction clutch. Such friction clutches which can be arranged as dry clutches in case of low powers and torques and which will typically be arranged as wet multi-disk clutches when used in a utility vehicle for example can also be used as starting elements. In this case too, the arrangement and coupling of the electrical machine between the starting element and the powershift transmission lead to a hybridized drive train with the aforementioned advantages.

An especially favorable and advantageous use of the drive train in accordance with the invention is provided for the use in utility vehicles. The drive train can principally be used in all kinds of trackless motor vehicles or even rail-bound vehicles. As a result of the comparatively high mass of utility vehicles, especially in comparison with passenger cars, the configuration in accordance with the invention can make use of its inherent advantages in the utilization of recuperated energy for renewed acceleration. This applies especially to city buses, especially buses for urban transport. These city buses typically used in urban transport frequently move for only short distances from one stop to the next. As a result, they need to accelerate and brake often, so that the energetic and ecological advantage of the hybrid drive can be utilized especially well. As a result of the possibility to travel in a highly energy-efficient way in low-traffic zones or the like without having to drag along the primary drive unit such as an internal combustion engine and without having to operate said engine at all, a special advantage arises in this case because there will be especially fewer emissions in respect of noise and pollutants in these sensitive areas.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 shows a schematic view of the arrangement of the drive train in accordance with the invention;

FIG. 2 shows a detailed view of a section of a first embodiment of the drive train in accordance with the invention in a first shifting state;

FIG. 3 shows a detailed view of a section of the first embodiment of the drive train in accordance with the invention in a second shifting state;

FIG. 4 shows a detailed view of a section of the first embodiment of the drive train in accordance with the invention in a third shifting state;

FIG. 5 shows a detailed view of a section of the first embodiment of the drive train in accordance with the invention in a fourth shifting state;

FIG. 6 shows a detailed view of a section of the first embodiment of the drive train in accordance with the invention in a fifth shifting state;

FIG. 7 shows a detailed view of a section of the first embodiment of the drive train in accordance with the invention in a sixth shifting state;

FIG. 8 shows a detailed view of a section of the first embodiment of the drive train in accordance with the invention in a seventh shifting state;

FIG. 9 shows a detailed view of a section of a second embodiment of the drive train in accordance with the invention;

FIG. 10 shows a detailed view of a section of a third embodiment of the drive train in accordance with the invention;

FIG. 11 shows a detailed view of a section of a fourth embodiment of the drive train in accordance with the invention;

FIG. 12 shows a detailed view of a section of a fifth embodiment of the drive train in accordance with the invention;

FIG. 13 shows a detailed view of a section of a sixth embodiment of the drive train in accordance with the invention;

FIG. 14 shows a detailed view of a section of a seventh embodiment of the drive train in accordance with the invention;

FIG. 15 shows a detailed view of a section of an eighth embodiment of the drive train in accordance with the invention;

FIG. 16 shows a detailed view of a section of a ninth embodiment of the drive train in accordance with the invention;

FIG. 17 shows a detailed view of a section of a tenth embodiment of the drive train in accordance with the invention; and

FIG. 18 shows a detailed view of a section of an eleventh embodiment of the drive train in accordance with the invention;

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

FIG. 1 shows a principal view of a drive train 1 as can be used in a utility vehicle for example, especially a city bus for urban transport. A primary drive unit 2 of the drive train 1 is arranged in this case by way of example as an internal combustion engine, especially a diesel engine. Alternative embodiments of the primary drive unit are possible at any time, e.g. the use of gas turbines, various types of motors or similar machines which provide mechanical rotational power.

In the direction of the power flow in the drive train 1, which shall be defined for the present description in the direction occurring in the drive, a starting element 3 follows the primary drive unit 2, which starting element comprises at least one coupling, e.g. a lock-up clutch 5, a hydrodynamic coupling 4.1, 4.2, 4.3 and/or a mechanical starting clutch 43. An electrical machine 6 is connected to the starting element 3 in the direction of the power flow, which is followed by a powershift transmission 7. The power take-off 11 of the powershift transmission 7 is connected with the drive wheels 9 via a further transfer gear 8 or differential in the principal and schematic view of the drive train 1 as illustrated here. The drive wheels 9 are used for driving the vehicle equipped with the drive train 1, which vehicle is not shown in its entirety. The electrical machine can preferably be arranged as a permanent-magnet synchronous motor (PSM).

The configuration of the drive train 1 in the manner as shown in FIG. 1 allows the use of a very small and highly efficient electrical machine 6 in the manner as shown in FIG. 1. Since it is arranged between the starting element 3 and the powershift transmission 7, the electrical machine 6 merely needs to ensure a very low spread of its available torque or speed range since subsequently there will be a respective transmission to the speeds or torques required in the drive wheels 9 via the powershift transmission 7. On the other hand, the electrical machine 3 is arranged in such a way between the starting element 3 and the powershift transmission 7 that a decoupling of the primary drive unit 2 (which is the diesel engine in this case) from the electrical machine 6 can be realized, so that in the case of a standstill of the diesel engine 2 no drag losses are caused by the optionally necessary drag of the diesel engine 2 as a result of the operation of the electrical machine 6 as a generator or motor. The configuration can therefore be realized in an exceptionally compact way and allows a highly advantageous and energy-efficient use of the hybridized drive train 1 in the manner as described above.

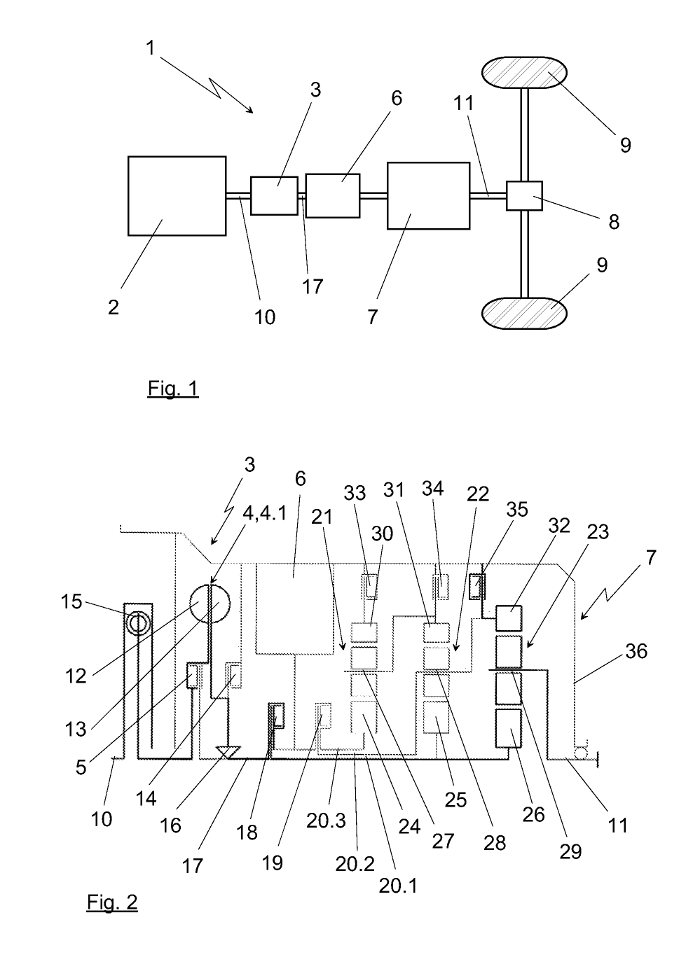

The illustrations of FIGS. 2 to 8 show an exemplary configuration of a section of a first embodiment of such a drive train 1, with merely the portion of the rotationally symmetrical configuration disposed above the rotational axis being illustrated. FIGS. 2 to 8 show different shifting states of the configuration, which will be explained below and will explain the functionality of the configuration thereby.

The illustration of FIG. 2 shows the starting element 3, the powershift transmission 7 and the interposed electrical machine 6. An input shaft 10 into the starting element 3 is shown in the illustration as chosen in FIG. 2 on the left. It is simultaneously the output shaft of the primary drive unit 2, or it is connected directly or indirectly with the same. The configuration as shown in FIG. 2 ends on the right side with output shaft 11 of the powershift transmission 7, which drives the drive wheels 9 directly or—as indicated in the illustration of FIG. 1—via a transfer gear 8. A hydrodynamic element 4 can be seen in the region of the starting element 3. In the embodiment as illustrated here, the hydrodynamic element 4 is shown as a hydrodynamic coupling 4.1 with controlled filling. The reference numeral 4.1 shall always indicate such a hydrodynamic coupling 4.1 with controlled filling below. It represents a first possible embodiment of the hydrodynamic element 4. The hydrodynamic coupling 4.1 consists in the known manner of a primary wheel 12 or a primary blade wheel 12 and a secondary wheel or secondary blade wheel 13. In operation of the hydrodynamic coupling 4.1, a cycle flow of a working medium utilized for power transmission is formed between these two blade wheels 12, 13 in a working chamber formed by them, as is generally known from hydraulic couplings 4.1 and is commonly applied therein. The hydrodynamic coupling 4.1 with controlled filling shall be understood in such a way that the volume of the working medium in the working chamber will be varied or controlled in a respective fashion in order to influence power transmission and to set the desired torque with the desired speed on the secondary side, i.e. on the side of the hydrodynamic coupling 4.1 facing the powershift transmission 7.

The illustration of FIG. 2 also shows a brake 14 for the secondary blade wheel 13, which will be explained below in closer detail. In addition to the hydrodynamic coupling 4, the starting element 3 also comprises a lock-up clutch 5 which can be realized as a dry clutch in form of a multi-disk clutch for example. The illustration of FIG. 2 further shows a damping element 15 which is known in this configuration and commonly used as a torsional vibration damper in internal combustion engines as the primary drive unit 2. The secondary blade wheel 13 is then connected via a freewheel 16 with the input shaft 17 of the powershift transmission 7. Said input shaft 17 is then divided by way of two couplings 18, 19 among three inputs 20.1, 20.2, 20.3 of the powershift transmission 7. A connection with the electrical machine 6 is further realized between the two couplings 18, 19. The electrical machine 6 is then rigidly connected with the input shaft 17 and accordingly rigidly connected with the input 20.3. The connection of the electrical machine 6 with the input 20.1 and 20.2 occurs via the couplings 18, 19. Three planetary sets 21, 22, 23 are realized here in the powershift transmission 7 by way of example, of which the suns 24, 25, 26 of one of the planets 27, 28, 29 and the hollow wheels or external gears 30, 31, 32 are respectively shown. The input 20.1 is connected in a torsion-proof fashion with the suns 25, 26 of the second and third planetary set 22, 23. The input 20.3 is connected in a torsion-proof manner with the sun 24 of the first planetary set 21. The third input 20.2 is connected with the planet 28 of the second planetary set 22 or its planet carrier. Furthermore, the planets 27, 28 of the first and second planetary set 21, 22 are respectively connected with the external gears 31, 32 of the following planetary set 22, 23. The external gears 30, 31, 32 can further be stalled individually via brakes 33, 34, 35. The output shaft 11 is then connected with the planet 29 of the last planetary set 23 or in the usual manner with the planet carrier. Such a powershift transmission 7 is known and commonly used in the state of the art.

The configuration of the powershift transmission 7 as shown in this document, as described below and as is frequently known as “Polak structure” from its inventor shall be understood in a merely exemplary manner because the core of the invention lies in the arrangement of the electrical machine 6 between the starting element 3 and the powershift transmission 7. That is why the powershift transmission 7 can certainly be arranged in another known and common manner without departing thereby from the scope of the present invention. The entire configuration as shown herein is arranged in a housing 36. The primary drive unit 2 can be directly adjacent to said housing on the side of the input shaft 10 or can be flanged on said housing 36.

In the illustration of FIG. 2, the power flow in a first shifting state, which is the first gear in this case, during starting with the starting element 3 is shown on the basis of the bold lines of the power flow. The lock-up clutch 5 is opened for this purpose, as are the brakes 14, 33 and 34 and the coupling 19. When the coupling 18 and brake 35 for the external gears 32 of the third planetary set 23 are closed, a power flow is obtained from the input shaft 10 to the primary blade wheel 12 and to the secondary blade wheel 13 in the known manner by the hydrodynamic cycle. It transfers power via the freewheel 16 and the input shaft 17 and the closed coupling 18 onto the input 20.1 of the powershift transmission 7. The output shaft 11 is driven by the planet 29 of said planetary set 23 from there via the sun 26 of the third planetary set 23 when the rim 32 of said planetary set 23 is stalled via the brake 35.

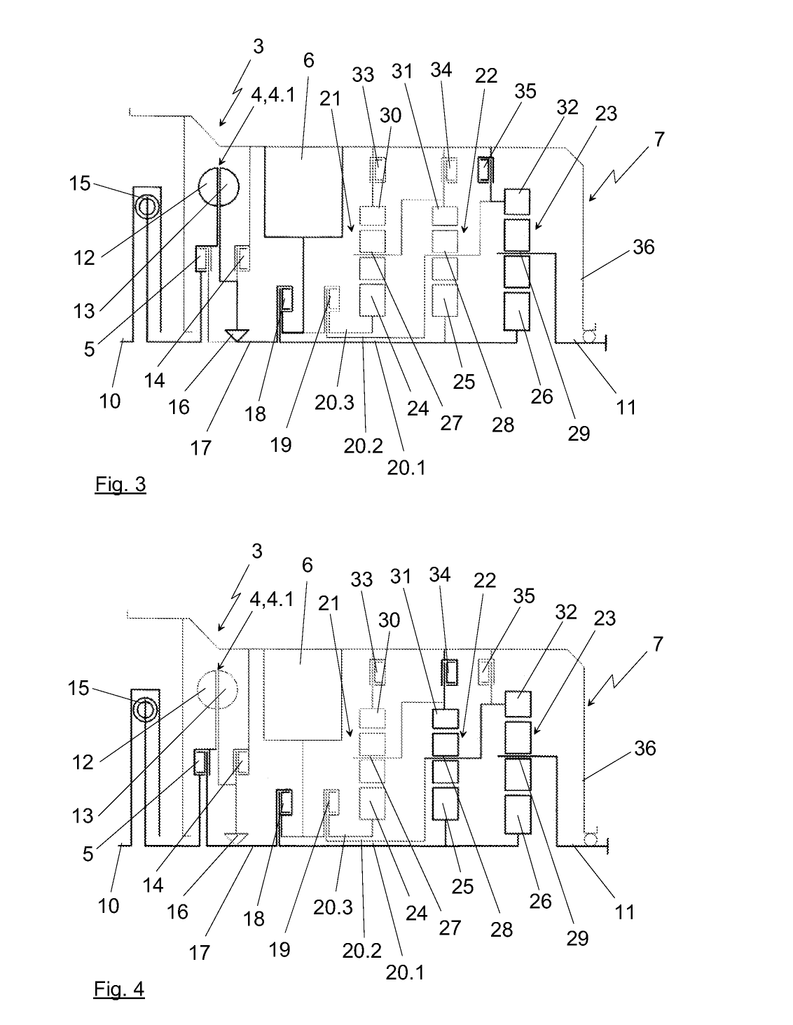

The configuration as shown in FIG. 3 also shows the first gear and describes combined starting via the hydrodynamic coupling 4.1, as already described with respect to FIG. 2 on the one hand and the electrical machine 6 on the other hand. A connection to the electrical machine 6 is additionally produced by the coupling 18 in addition to the connection of the input 20.1 with the input shaft 17 in a comparative configuration and comparative constellation of the brakes and couplings (as explained in FIG. 2), which electrical machine will operate motively in this case and will support the starting in a respective fashion.

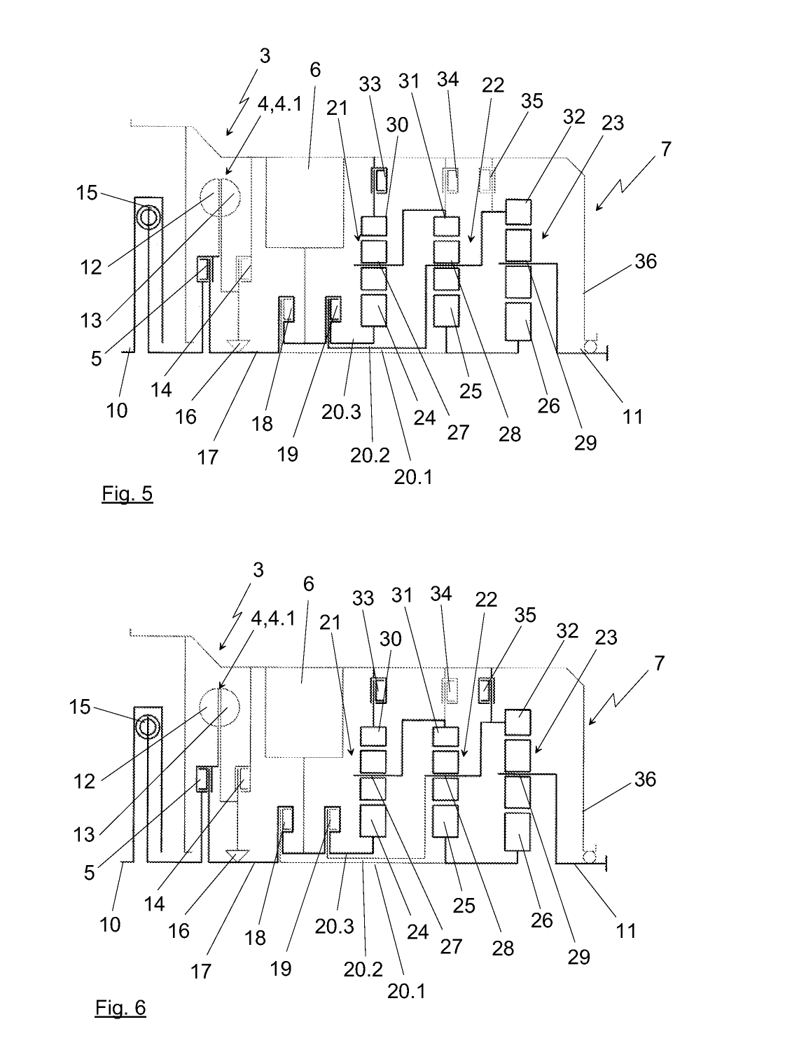

The illustration of FIGS. 4 and 5 show exemplary shifting states for two randomly selected forward gears, which in this case shows the second gear in the illustration of FIG. 4 and the fifth gear in the illustration of FIG. 5. In this configuration, the lock-up clutch 5 is accordingly closed. The hydrodynamic coupling 4.1 is therefore not in operation, but is circumvented. Brake 34 is closed for the second gear when coupling 18 is closed, whereas the brakes 33, 35 and 14 are open like the coupling 19. This leads to the power flow shown with the bold line from the input shaft 17 via the coupling 18 and the input 20.1 of the powershift transmission 7 to the two planetary sets 22 and 23 with the states as shown in FIG. 4. A respective speed is thus obtained in the output shaft 11 of the powershift transmission 7. The illustration of FIG. 5 shows a comparable configuration for the fifth gear. It merely differs by the triggering of the individual brakes and couplings as shifting elements. As a result, coupling 19 is closed this case in combination with the simultaneously closed brake 33, whereas the brakes 34, 35 and 14 are open like coupling 18. The lock-up clutch 5 is still respectively closed as long as there is no starting and the hydrodynamic coupling 4 is therefore deactivated. The power flow occurs in this case via the input 20.2 and 20.3 in the manner as indicated with the bold lines in the illustration of FIG. 5.

The illustration of FIG. 6 shows the reverse gear. When brakes 33 and 35 are closed and couplings 18 and 19 are open simultaneously, a power flow is obtained which is shown with the bold lines and which comprises a respective reversal in the direction of rotation in the powershift transmission 7. FIG. 6 shows the reverse gear with closed lock-up clutch 5, i.e. in a state as typically occurs after starting in reverse gear during the actual travel in reverse gear. The hydrodynamic coupling will be used accordingly when also starting in reverse gear, in analogy to starting in the forward gear.

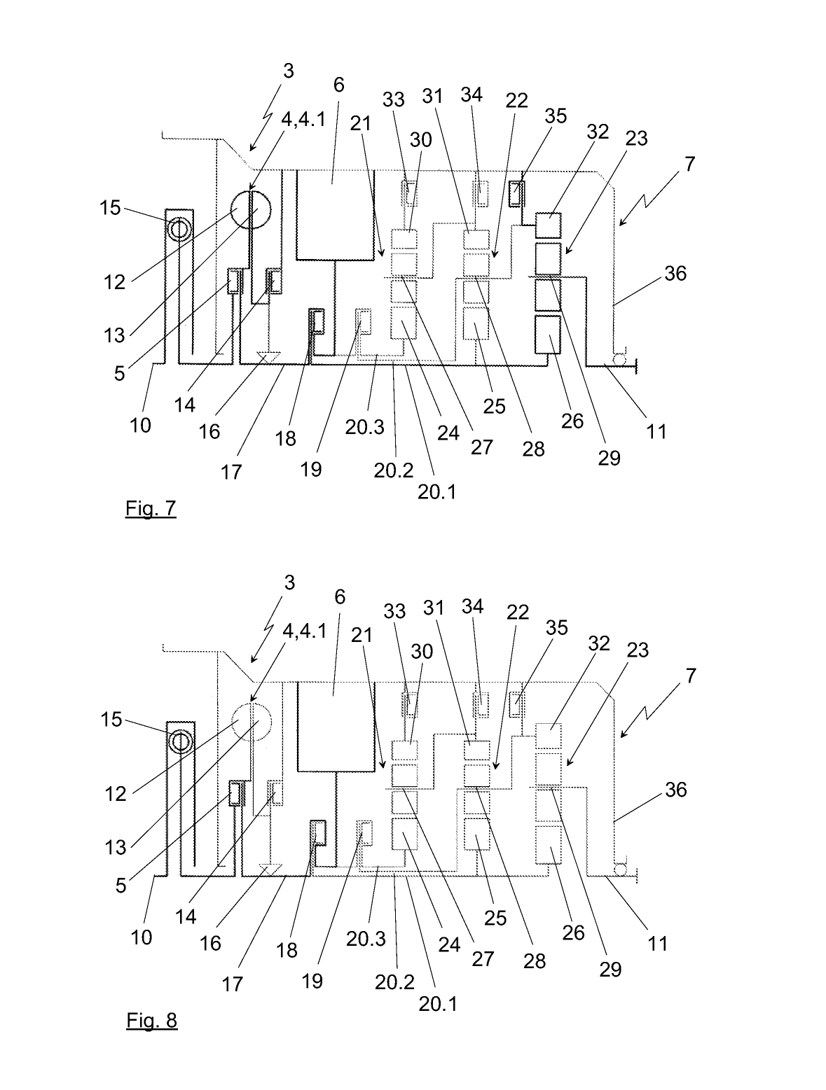

The illustration of FIG. 7 shows a further embodiment for a possible shifting state of the drive train in accordance with the invention. The power flow is respectively reversed because it concerns braking of the vehicle, i.e. braking of the output shaft 11 of the powershift transmission 7. In this state, the shifting state again corresponds to that of the first gear, as described above. Power now flows in a reverse manner from the output shaft 11 in the direction of the coupling 18 via the third planetary set 23 and the input 20.1 of the powershift transmission 7, which coupling 18 connects the input 20.1 of the powershift transmission 7 with the electrical machine 6 on the one hand and the input shaft 17 on the other hand. The electrical machine 6 can be driven in this state indirectly in the manner of a generator by the output shaft of the powershift transmission 7. Depending on the current which is taken from the electrical machine 6, a respective braking torque can be built up. In the case of sufficient storage capacity, power can be recuperated (the so-called recuperation) during braking of the vehicle in order to utilize said energy at a later point for renewed starting for example.

In specific states the storage capacity will now no longer be sufficient, so that no sufficient braking torque can be applied by the electrical machine 6. In this case, the primary blade wheel 12 can be co-driven by the drive of the input shaft 17 via the output shaft 11 and by the lock-up clutch 5 in such a way that the freewheel 16 prevents a direct drive of the secondary blade wheel 13. The secondary blade wheel 13 is stalled when the brake 14 is closed. The functionality of a retarder is therefore obtained with a rotating primary blade wheel 12 and a hydrodynamic coupling 4.1 which is filled with working medium, so that a respective power-dissipation torque is obtained by the swirling of the working medium between the rotating primary blade wheel 12 and the stalled secondary blade wheel, which power-dissipation torque is converted into heat. Said heat is dissipated in the known manner via a cooling system, or a liquid medium of the cooling cycle will be used directly as the working medium for the retarder. The retarder can therefore apply a braking torque in addition to the electrical machine 6, as is known in common practice in known configurations.

The illustration of FIG. 8 now shows an idling situation, in which the powershift transmission 7 is not driven and therefore the output shaft 11 of the powershift transmission 7 is also not driven. Nevertheless, a connection between the electrical machine 6 and the input shaft 10 and therefore the primary drive unit 2 (not shown in this drawing) can be produced by the lock-up clutch 5. This can be utilized for example in order to drive the electrical machine in the manner of a generator, e.g. for standing current supply of the vehicle or the like. Conversely, the electrical machine 6 can further be decoupled from the primary drive unit 2 and the starting element 3 in an analogous manner, so that purely electrical operation of the drive train 1 by the electrical machine 6 and the powershift transmission 7 is also possible without having to entrain the hydrodynamic coupling 4.1 and/or the primary drive unit 2.

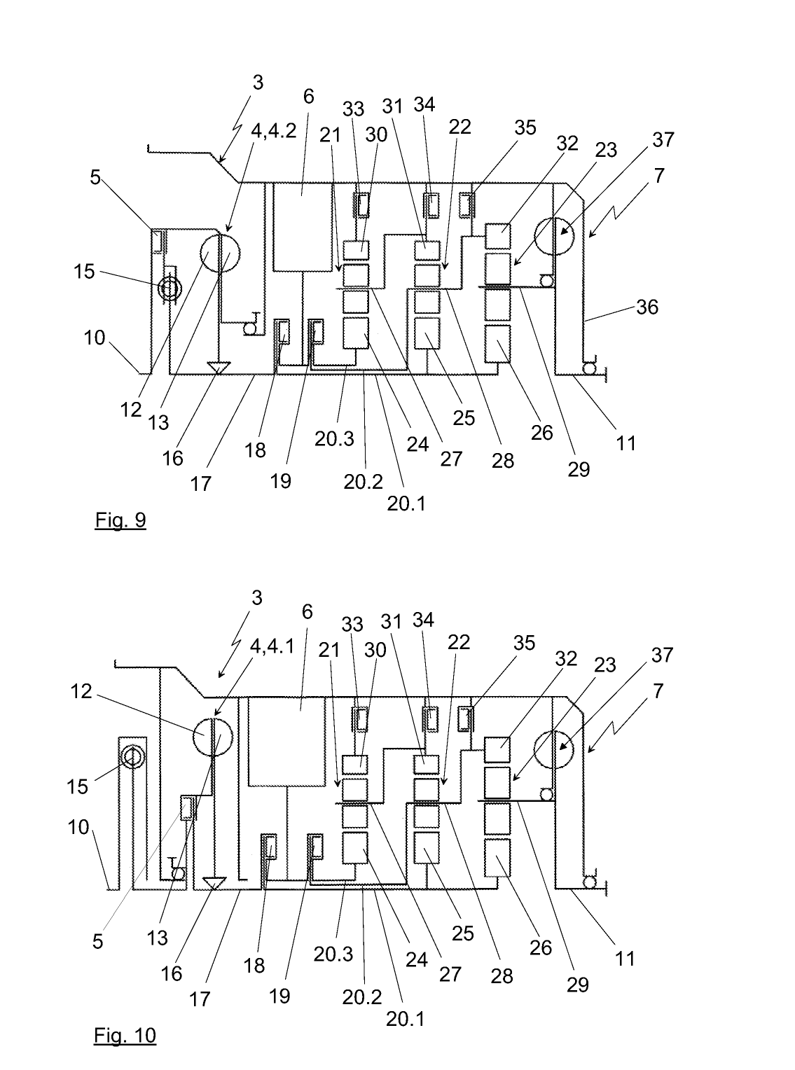

The illustration of FIG. 9 shows a second embodiment of the drive train 1 in a manner comparable with FIGS. 2 to 8. Since the different gear steps and driving states can be realized similar to those described in FIGS. 2 to 8, FIGS. 9 to 18 merely show the structures of the configurations of the various possible embodiments of the drive train 1 without the thickness of the lines symbolizing the power flow, as was the case in FIGS. 2 to 8.

In the configuration as shown in FIG. 9, the hydraulic element 4 is also arranged as a hydrodynamic coupling, which is arranged with a rotating housing and is provided as a hydrodynamic coupling 4.2 with constant filling. The hydrodynamic coupling 4.2 with constant filling shall be understood with respect to its functionality in such a way that it is always filled at a constant degree of filling. Since the lock-up clutch 5 is closed in non-operation of the hydrodynamic coupling 4.2 and the components therefore revolve with the same rotational speed, the continually filled hydrodynamic coupling 4.2 is non-critical concerning ventilation losses. Otherwise, the configuration substantially corresponds to the configuration as already described above. In addition, a secondary retarder 37 is provided between the planets or the planet carrier 29 of the third planetary set 23 and the power take-off 11, which secondary retarder is utilized in the known manner as a wear-free retarder. This is especially useful in the embodiment as shown in FIG. 9 because the hydrodynamic coupling 4.2, other than the hydrodynamic coupling 4.1, cannot be shifted together with the brake 14 in such a way that it can be used as a primary retarder.

The illustration of FIG. 10 shows a configuration very similar to the configuration as shown in FIG. 9. The only difference is that a housing of the hydrodynamic coupling 4.2 is arranged to be fixed in relation to the housing 36, whereas it was arranged in a revolving manner in the illustration of FIG. 9. The variant of the hydrodynamic coupling 4.2 with static housing as shown in FIG. 10 will therefore only be filled in the first gear and in the reverse gear. Ventilation losses in the region of the hydrodynamic coupling 4.2 can thereby be minimized. The characteristic curve of the coupling needs to be respectively adjusted to the used primary drive unit 2.

The control of the starting process via the hydrodynamic coupling 4.2 according to FIGS. 9 and 10 occurs in this case exclusively via the position of the load transmitter of the primary drive unit. The speeds and the torque pickup between the primary side 12 and the secondary side 13 of the hydrodynamic coupling 14 are obtained from the characteristic curves both of the hydrodynamic coupling 4.2 and the primary drive unit 2.

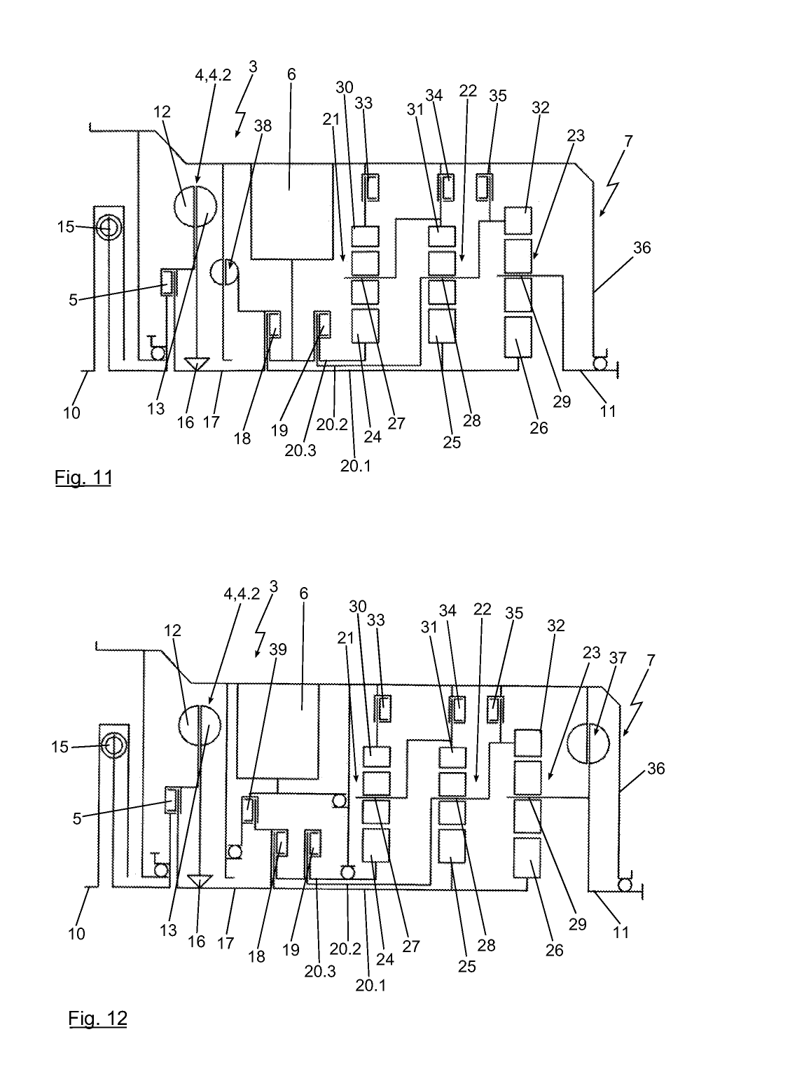

The illustration of the FIG. 11 again refers to the configuration as shown in FIG. 10. Instead of the secondary retarder 37, a primary retarder 38 is arranged in the power flow on the side of the powershift transmission 7 facing the primary drive unit 2. The previously described secondary retarder 37 can then be omitted.

The embodiment of the drive train 1 as shown in FIG. 12 also refers again to the embodiment as already explained within the scope FIG. 10. In addition, the possibility is provided via a further coupling 39 to selectively engage the electrical machine 6 in the power flow or to remove the same if necessary. This may be advantageous for certain constellations. These advantages need to be weighed carefully in the construction because the further coupling 39 will obviously lead to an additional need for space and components.

The illustration of FIG. 13 again refers to the configuration as explained within the scope of FIG. 9. A permanently filled hydrodynamic coupling 4.3 is shown instead of the hydrodynamic coupling 4.2 with constant filling. Said permanently filled hydrodynamic coupling 4.3 comprises a displaceable throttling element 40 which can be displaced into the cycle flow in such a way that the power input can be varied by the displaceable throttling element 40. The power input is therefore controlled via the throttling element 40. As a result, the primary drive unit 2 (e.g. an internal combustion engine) can be relieved during run-up and pressed down under constant load. The interaction of primary drive unit and hydrodynamic coupling 4.3 can therefore be influenced within wide margins. The adjustment between the primary drive unit and the powershift transmission 7 does not occur in this case by different coupling variants, but by controlling the displaceable throttling element 40. This leads to the advantage that the primary drive unit 2 can be guided in a purposeful fashion into specific operating ranges in this embodiment. As a result, an adjustment to the characteristic diagram of the primary drive unit 2 is possible in a starting process.

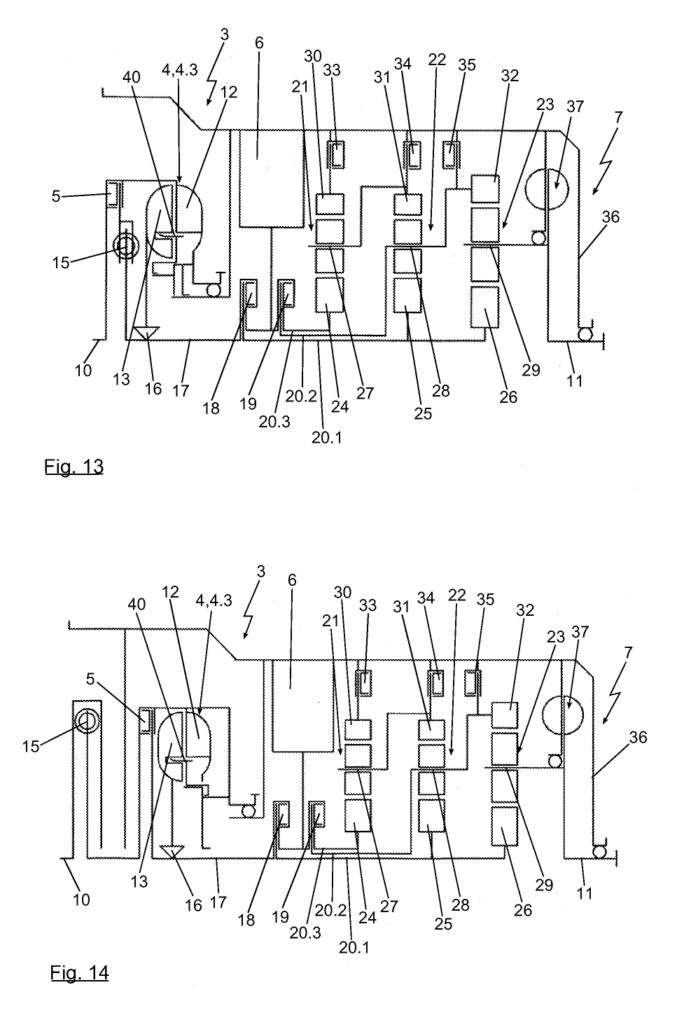

The illustration of FIG. 14 again shows a comparable configuration as in the illustration of FIG. 13. The only difference is that a housing of the hydrodynamic coupling 4.3, in the region of which the displaceable throttling element 40 is also arranged, is arranged in a torsion-proof manner in relation to the housing 36, which was not the case in the configuration as shown in FIG. 13.

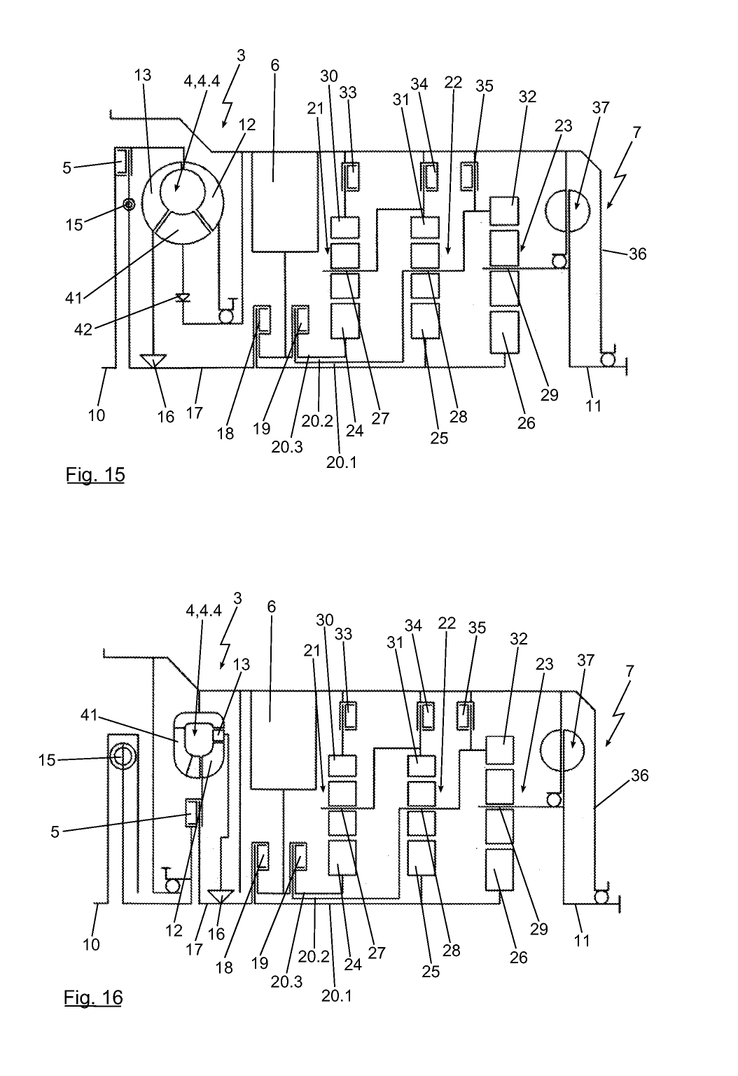

The illustration of FIG. 15 shows an eighth embodiment of the drive train 1 in accordance with the invention. The hydrodynamic element 4 is arranged in this eighth embodiment as a hydrodynamic torque converter 4.4. Said torque converter 4.4 is arranged in the illustration of FIG. 15 with a revolving housing. It also comprises a guide wheel or a guide apparatus 41 in addition to the primary side 12 which is connected with the primary drive unit 2 and a converter which is typically designated as a pump and the secondary side 13 which is connected via the freewheel 16 with the powershift transmission 7 and which is typically designated as a turbine in the case of a converter, which guide wheel or guide apparatus is connected in the illustrated embodiment by a freewheel 42 with the housing 36. The freewheel 16 acts as a directional coupling and ensures that the secondary side 13 is decoupled from the electrical machine 6 during purely electrical driving. Ventilation losses are therefore avoided in a static primary drive unit 2. The characteristic curve of the hydrodynamic torque converter 4.4 also needs to be adjusted to the used primary drive unit 2. A control of the starting process occurs then via the position of the load transmitter of the primary drive unit. The speed and torque pickup of the primary side 12 and the secondary side 13 of the torque converter 4.4 are obtained from the characteristic curves of the torque converter 4.4 and the primary drive unit 2. In this capacity as a starting element, the torque converter 4.4 comes with the advantage that the increase of the starting torque with high slip is enabled.

The illustration in FIG. 16 describes the same configuration as in the eighth embodiment in the illustration of FIG. 15, with the housing of the hydrodynamic torque converter 4.4 being connected in a torque-proof manner with the housing 36 in this case and the freewheel 42 can therefore be omitted. The guide wheel 41 is also connected in this case in a torsion-proof way with the housing 36. The turbine or secondary side 13 is coupled via the freewheel 16 with the powershift transmission 7 in a manner that has already been described several times above. As a result of the housing of the hydrodynamic converter 4.4 which is connected in a torsion-proof manner with the housing 36, filling of the hydrodynamic converter 4.4 with working medium will only occur in the first gear and in the reverse gear, similar to the hydrodynamic coupling 4.2 with constant filling, in order to minimize the occurring ventilation losses in the area of the hydrodynamic converter 4.4 in the other gears. Discharging must also occur for purely electrical drive with static primary drive unit 2 for the purpose of avoiding ventilation losses.

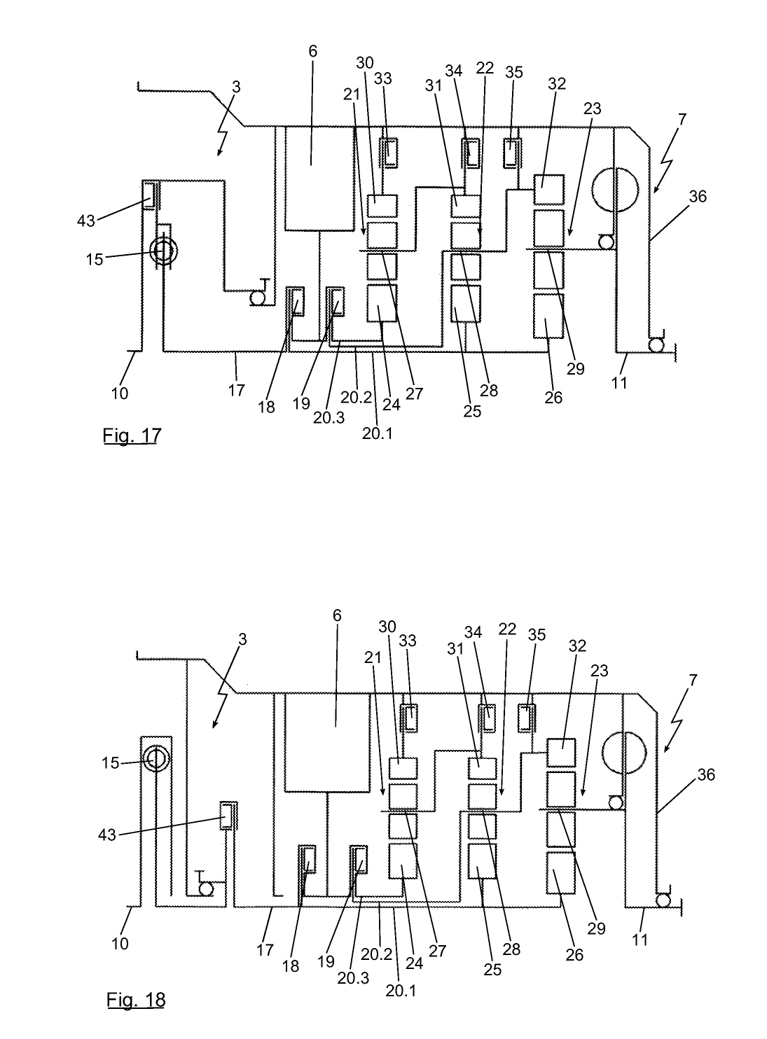

The illustrations of FIGS. 17 and 18 show a tenth and eleventh embodiment of the drive train 1 in accordance with the invention. These two embodiments do not use any hydrodynamic element 4 with lock-up clutch 5 in the region of the starting element, but a friction clutch 43 in the region of the starting element. Since the drive train 1 will be described by reference to a drive train for a utility vehicle as already mentioned, the powers required for starting are comparatively high. The friction clutch 43 of the starting element 3 in the embodiment according to FIGS. 17 and 18 shall be arranged as a multi-disk clutch, especially as a wet multi-disk clutch. The multi-disk clutch will be controlled hydraulically for example, so that the transmitted torque can be set in the respective manner as a result of this control. The configuration will be lubricated and cooled by oil, because a respectively high quantity of heat will be obtained by the transmission in the clutch. The configuration of the drive train 1 with the friction clutch 43 in the starting element 3 also allows guiding the primary drive unit 2 in specific operating ranges because the torque pickup of the fiction clutch 43 can be controlled by an actuating pressure on the individual disks of the same. The configuration of the friction clutch 43 as a wet multi-disk clutch comes with the advantage that fewer components are required. However, the requirement placed on the control quality for the actuating pressure is comparatively high.

The variants described above have mostly been illustrated with the secondary retarder 37. It shall be understood in a purely optional manner and it can be replaced in any way by the primary retarder 38 or also be omitted completely. The variants can be combined with one another accordingly, so that the coupling of the electrical machine 6 via the further coupling 39 can also be used for example in all embodiments in which it is not shown. Therefore, there is a respective possibility to separately mount the rotor of the electrical machine and to perform the connection of the electrical machine with the input shafts 20.1, 20.2, 20.3 of the powershift transmission 7 via the further coupling 39. No-load losses of the electrical machine 6 can therefore substantially be reduced. A multi-disk clutch can be used as the preferable configuration for the coupling 39, which can be arranged for example as “uncontrolled open” or “uncontrolled closed”. The arrangement as “uncontrolled closed” offers the advantage that the actuation of the coupling 39 separates the rotor of the electrical machine 6 from the inputs 20.1, 20.2, 20.3 of the powershift transmission 7, so that it comes to a standstill. As a result, power losses in the rotary transmission leadthrough of the pressure oil for control will be avoided.

In addition to the embodiment of most brakes and couplings as multi-disk clutches as described and shown herein, it would obviously also be possible to arrange them or a part of them in form of jaw couplings. These claw couplings, which can be shifted at low relative speeds directly or at large relative speeds via a synchronization device, offer the advantage that they can be arranged in a comparatively simple, light and cost-effective way.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A drive train for a motor vehicle, said drive train comprising:
a primary drive unit;
a powershift transmission which is arranged behind said primary drive unit in a direction of a power flow;
a starting element which is arranged in said power flow between said primary drive unit and said powershift transmission, said starting element including at least one coupling;
an electrical machine which is arranged in said power flow between said starting element and said powershift transmission;
at least one retarder which is arranged in said power flow at least one of before and after said powershift transmission.

2. The drive train according to claim 1, wherein said powershift transmission includes an input shaft, said electrical machine being connected to said input shaft of said powershift transmission.

3. The drive train according to claim 1, wherein said starting element includes a hydrodynamic element.

4. The drive train according to claim 3, wherein said starting element includes a mechanical lock-up clutch for said hydrodynamic element.

5. The drive train according to claim 4, wherein said lock-up clutch is arranged as a dry clutch.

6. The drive train according to claim 3, wherein said hydrodynamic element is arranged as a hydrodynamic coupling with a constant filling.

7. The drive train according to claim 3, wherein said hydrodynamic element is arranged as a permanently filled hydrodynamic coupling with a displaceable throttling ring.

8. The drive train according to claim 3, wherein said hydrodynamic element is arranged as a hydrodynamic converter.

9. The drive train according to claim 3, wherein said hydrodynamic element is arranged as a hydrodynamic coupling with a controlled filling.

10. The drive train according to claim 9, further including a freewheel, said hydrodynamic element including a secondary wheel, said powershift transmission including an input shaft, said secondary wheel of said hydrodynamic element being connected via said freewheel to said input shaft of said powershift transmission.

11. The drive train according to claim 9, further including a braking device, said secondary wheel of said hydrodynamic coupling configured for being stalled via said braking device.

12. The drive train according to claim 1, wherein said starting element is arranged as a friction clutch.

13. The drive train according to claim 12, wherein said friction clutch is arranged as a wet multi-disk clutch.

14. A method of using a drive train for a drive of a utility vehicle, said method comprising the steps of:
providing the drive train for the utility vehicle, the drive train including:
a primary drive unit;
a powershift transmission which is arranged behind said primary drive unit in a direction of a power flow;
a starting element which is arranged in said power flow between said primary drive unit and said powershift transmission, said starting element including at least one coupling;
an electrical machine which is arranged in said power flow between said starting element and said powershift transmission;
at least one retarder which is arranged in said power flow at least one of before and after said powershift transmission;
using the drive train for the drive of the utility vehicle.

15. The method of using according to claim 15, wherein the utility vehicle is one of a city bus and a bus for an urban transport.
